(19) United States
(12) Patent Application Publication
(10) Pub. No.: US 2026/0192449 A1
(43) Pub. Date: Jul. 9, 2026

(54) CONTROL METHOD AND ROBOT SYSTEM

(71) Applicant: SEIKO EPSON CORPORATION, Tokyo (JP)

(72) Inventor: Hidetoshi SAITO, FUJIMI-MACHI (JP)

(21) Appl. No.: 19/439,480

(22) Filed: Jan. 5, 2026

(30) Foreign Application Priority Data
Jan. 7, 2025 (JP) 2025-002167

(51) Int. Cl. B25J 9/16; B25J 11/00; B25J 13/08; B41J 3/407

(52) U.S. Cl. CPC B25J 9/1664; B25J 11/0075; B25J 13/089; B41J 3/4073

(57) ABSTRACT

A control method is a control method of a robot system that drives a robot arm holding one of a working tool and an object and moves the working tool and the object relative to each other to perform work on the object with the working tool, the control method including generating a trajectory of the one based on a shape of the object, and setting responsiveness of the robot arm in a portion of the trajectory where a rate of change of curvature of the object is large to be higher than responsiveness in a portion where the rate of change is small.

### CROSS-REFERENCE TO RELATED APPLICATIONS

The present application is based on, and claims priority from JP Application Serial Number 2025-002167, filed Jan. 7, 2025, the disclosure of which is hereby incorporated by reference herein in its entirety.

### BACKGROUND OF THE INVENTION

### 1. Technical Field

The present disclosure relates to a control method and a robot system.

### 2. Related Art

JP-A-2023-020007 describes a printing method for printing on an object using a robot. In such a printing method, a robot including a robot arm, a moving stage disposed at a distal end portion of the robot arm, and a print head attached to the moving stage is used, and printing on the object is performed by discharging ink from the print head while moving the print head with respect to the object by using the moving stage in a state where the robot arm is stopped. In addition, at this time, a moving range of the moving stage is set such that a printing range at a portion where the curvature of the object is large is smaller than the printing range at a portion where the curvature is small.

However, even if, as in the printing method of JP-A-2023-020007, the moving range of the moving stage is set such that the printing range at the portion where the curvature of the object is large is smaller than the printing range at the portion where the curvature is small, at a portion where the curvature changes steeply, positional deviation of the print head with respect to the printing trajectory is likely to occur, and there is a possibility that printing quality deteriorates.

### SUMMARY OF THE INVENTION

A control method according to the present disclosure is a control method of a robot system that drives a robot arm holding one of a working tool and an object and moves the working tool and the object relative to each other to perform work on the object with the working tool, the control method including generating a trajectory of the one based on a shape of the object, and setting responsiveness of the robot arm in a portion of the trajectory where a rate of change of curvature of the object is large to be higher than responsiveness in a portion where the rate of change is small.

A control method according to the present disclosure is a control method of a robot system that drives a robot arm holding one of a working tool and an object and moves the working tool and the object relative to each other to perform work on the object with the working tool, the control method including generating a trajectory of the one based on a shape of the object, and setting a moving speed of the working tool in a portion of the trajectory where a rate of change of curvature of the object is large to be lower than a moving speed in a portion where the rate of change is small.

A robot system according to the present disclosure includes a robot arm configured to hold one of a working tool and an object, and a control device configured to control drive of the robot arm, in which the control device drives the robot arm and relatively moves the working tool and the object to perform work on the object by the working tool, the control device generates a trajectory of the one based on a shape of the object, and sets responsiveness of the robot arm in a portion of the trajectory where a rate of change of curvature of the object is large to be higher than responsiveness in a portion where the rate of change is small.

A robot system according to the present disclosure includes a robot arm configured to hold one of a working tool and an object, and a control device configured to control drive of the robot arm, in which the control device drives the robot arm and relatively moves the working tool and the object to perform work on the object by the working tool, the control device generates a trajectory of the one based on a shape of the object, and sets a moving speed of the working tool in a portion of the trajectory where a rate of change of curvature of the object is large to be lower than a moving speed in a portion where the rate of change is small.

### BRIEF DESCRIPTION OF DRAWINGS

FIG. 1 is an overall view of a robot system according to a first embodiment.

FIG. 2 is a plan view showing a moving stage and a print head included in a robot shown in FIG. 1.

FIG. 3 is an exploded perspective view showing the print head.

FIG. 4 is a perspective sectional view showing the print head.

FIG. 5 is a diagram showing an example of a printing trajectory.

FIG. 6 is a diagram for explaining a method of determining a feedback gain.

FIG. 7 is a table showing the feedback gain for each region.

FIG. 8 is a block diagram of a control section that controls the drive of joints.

FIG. 9 is a flowchart for explaining a printing method.

FIG. 10 is a table showing a control cycle for each region used in a second embodiment.

FIG. 11 is a diagram showing an example of a printing trajectory according to a third embodiment.

FIG. 12 is a table showing the feedback gain for each row.

FIG. 13 is a table showing responsiveness of each region used in a fourth embodiment.

FIG. 14 is a diagram showing a method of moving a print head in a robot system according to a fifth embodiment.

FIG. 15 is a table showing a moving speed for each region used in a sixth embodiment.

FIG. 16 is a flowchart for explaining the printing method.

FIG. 17 is a table showing a moving speed for each region used in a seventh embodiment.

### DETAILED DESCRIPTION OF THE INVENTION

Hereinafter, a control method and a robot system according to the present disclosure will be described in detail based on embodiments shown in the accompanying drawings.

### First Embodiment

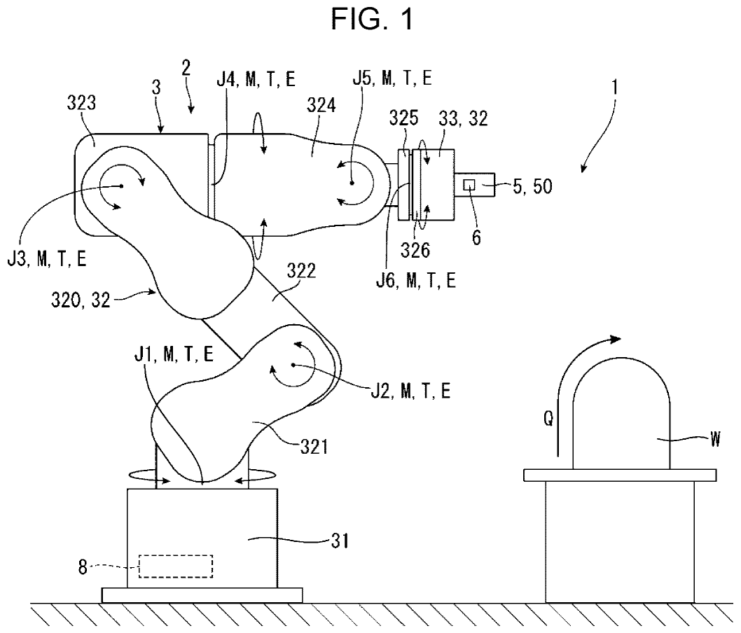

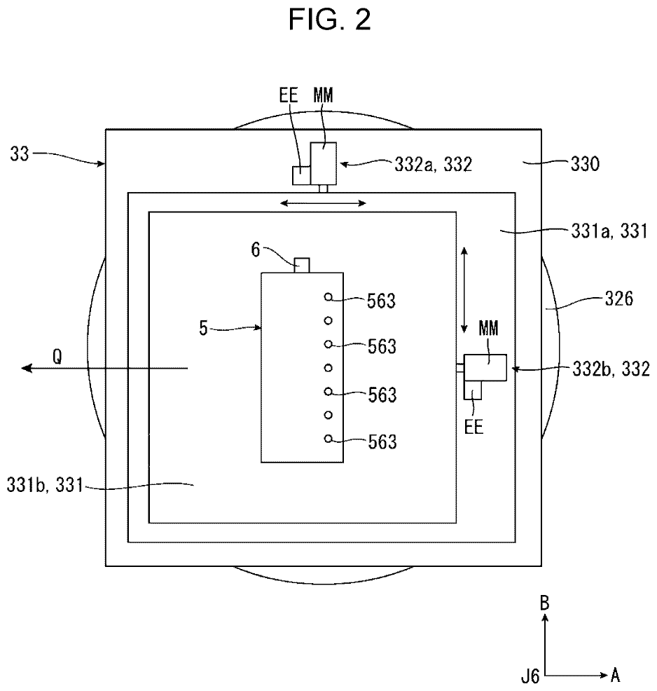

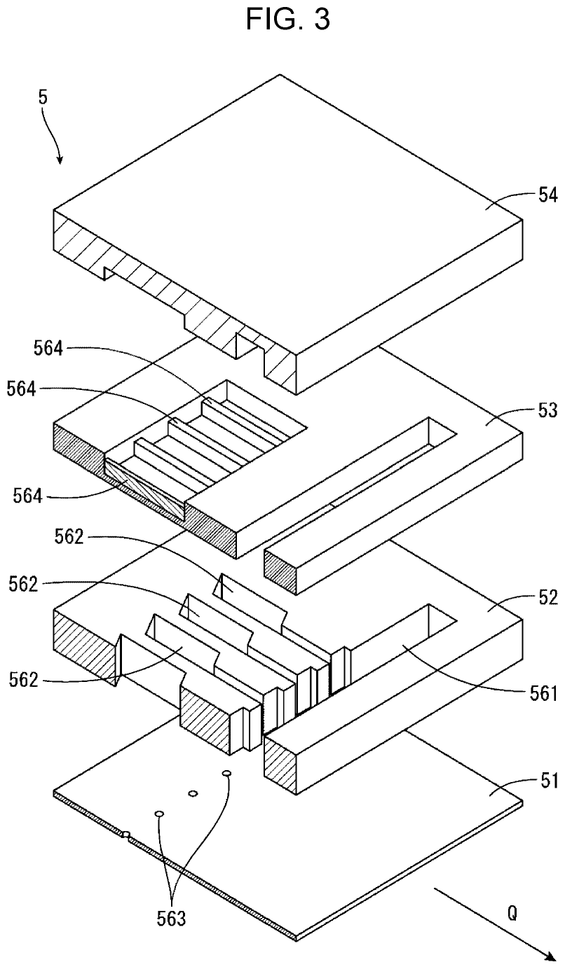

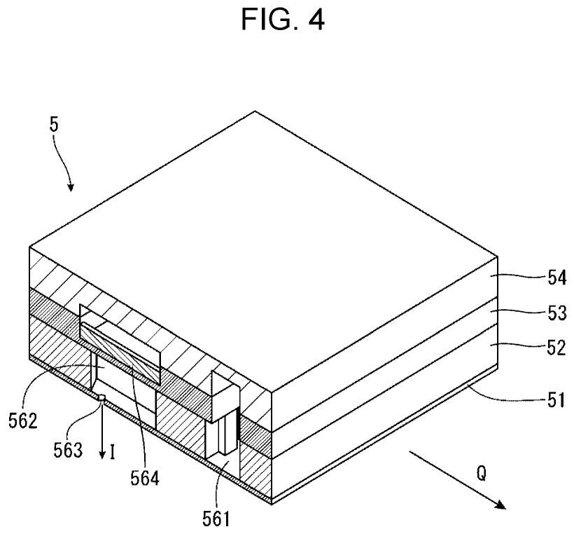

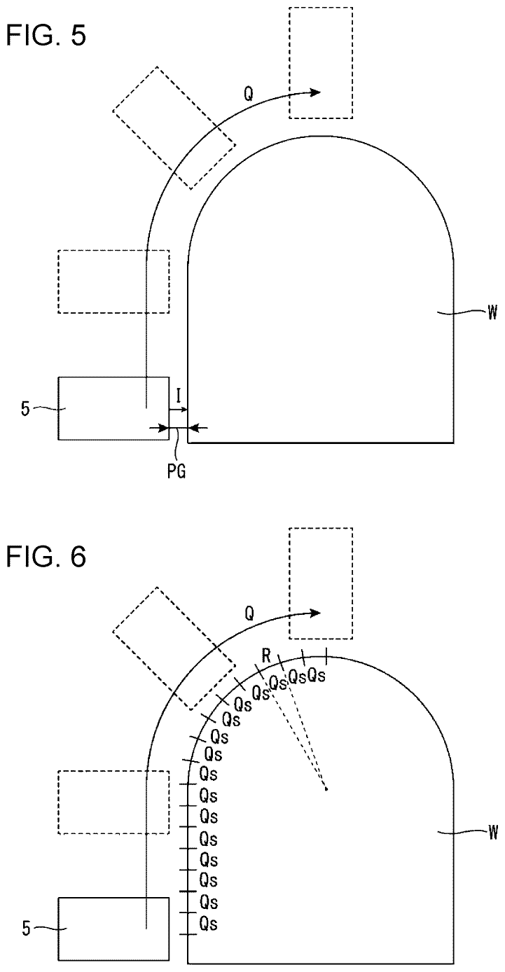

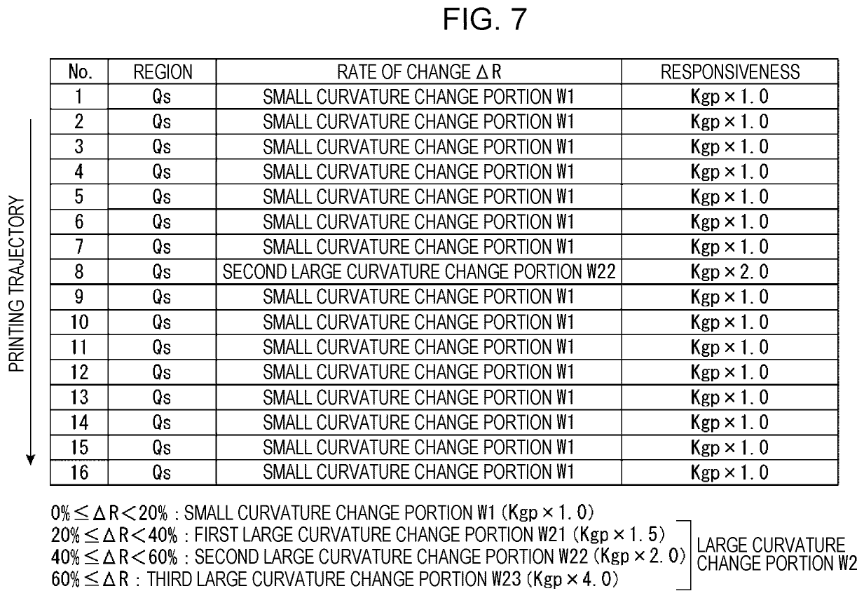

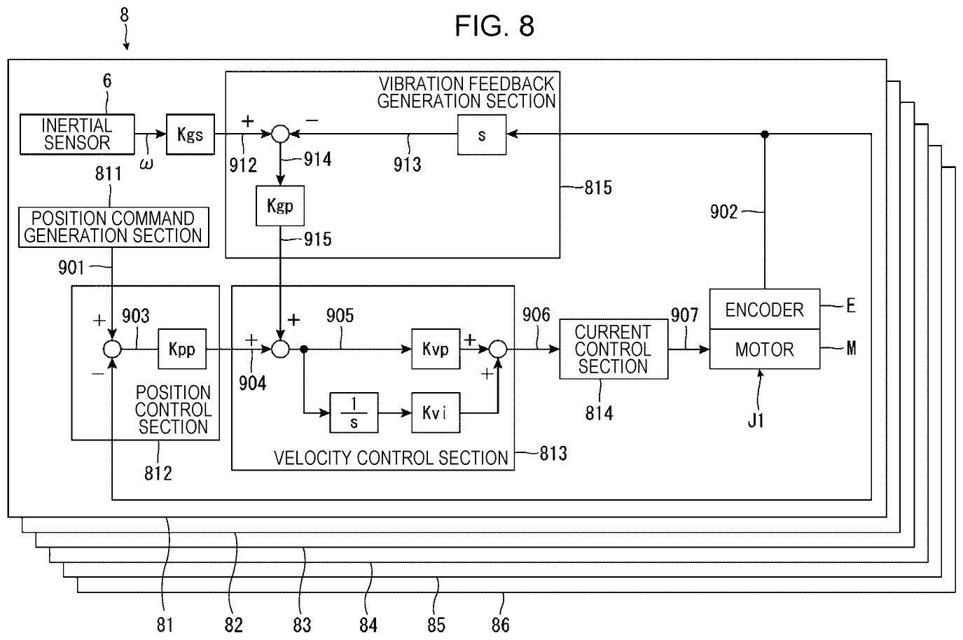

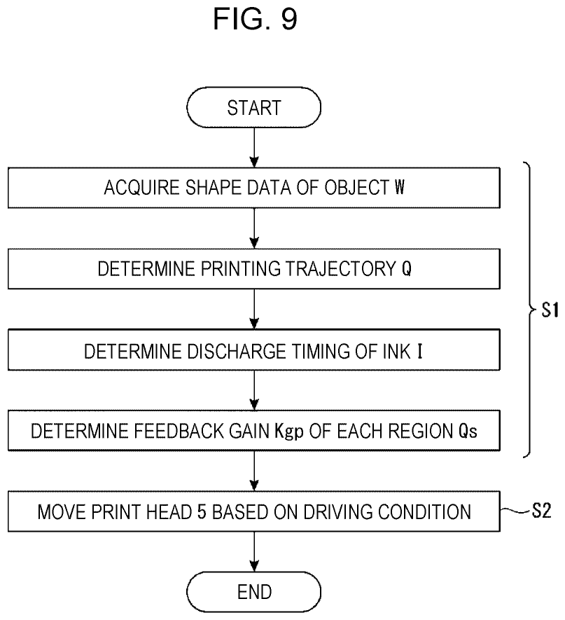

FIG. 1 is an overall view of a robot system according to a first embodiment. FIG. 2 is a plan view showing a moving stage and a print head included in a robot shown in FIG. 1. FIG. 3 is an exploded perspective view showing the print head. FIG. 4 is a perspective sectional view showing the print head. FIG. 5 is a diagram showing an example of a printing trajectory. FIG. 6 is a diagram for explaining a method of determining a feedback gain. FIG. 7 is a table showing the feedback gain for each region. FIG. 8 is a block diagram of a control section that controls the drive of joints. FIG. 9 is a flowchart for explaining the printing method.

A robot system 1 shown in FIG. 1 includes a robot 2 and a control device 8 that controls drive of the robot 2. In addition, the robot 2 includes a robot main body 3 including a robot arm 32, a working tool 50 disposed at a tip end of the robot arm 32, and an inertial sensor 6 disposed in the working tool 50. In such a robot system 1, the robot arm 32 is driven by the control device 8, and the working tool 50 and an object W are relatively moved, so that predetermined work is performed on the object W by the working tool 50.

In particular, the working tool 50 of the present embodiment is the print head 5, and the robot system 1 is a printing system for performing printing on the object W by discharging ink I from the print head 5 at a predetermined timing while moving the print head 5 along a printing trajectory Q using the robot arm 32. However, the working tool 50 is not particularly limited, and may be, for example, a tool such as a driver.

In the robot system 1 of the present embodiment, the robot arm 32 holds the print head 5 and performs printing while moving the print head 5 with respect to the object W fixed to a stage or the like, but the present disclosure is not limited thereto. For example, contrary to the present embodiment, the robot arm 32 may hold the object W and perform printing while moving the object W with respect to the print head 5 fixed to the stage or the like. Further, the object W may be held by another robot arm (not shown), and printing may be performed while the print head 5 and the object W are moved together.

### Robot Main Body 3

As shown in FIG. 1, the robot main body 3 is a six-axis vertical articulated robot having six drive axes, and includes a base 31 fixed to a mounting table, a floor, or the like, and the robot arm 32 that is rotatably coupled to the base 31. The robot arm 32 includes a robot arm main body 320 and a moving stage 33 disposed at a distal end portion of the robot arm main body 320.

The robot arm main body 320 has a configuration in which six arms 321, 322, 323, 324, 325, and 326 are rotatably coupled in this order from the base 31 side, and includes six joints J1, J2, J3, J4, J5, and J6. Specifically, the arm 321 is rotatably coupled to the base 31 via the joint J1. The arm 322 is rotatably coupled to the arm 321 via the joint J2. The arm 323 is rotatably coupled to the arm 322 via the joint J3. The arm 324 is rotatably coupled to the arm 323 via the joint J4. The arm 325 is rotatably coupled to the arm 324 via the joint J5. The arm 326 is rotatably coupled to the arm 325 via the joint J6.

Among the joints J1 to J6, the joints J2, J3, and J5 are bending joints, and the joints J1, J4, and J6 are twisting joints. Each of the joints J1, J2, J3, J4, J5, and J6 is provided with a drive mechanism including a motor M as a driving source, a reduction gear T that decelerates rotation of the motor M to increase and output torque, and an encoder E that detects a rotation amount of the motor M. By independently moving each of the joints J1, J2, J3, J4, J5, and J6, the print head 5 can be moved in a desired direction at a desired posture and speed.

The moving stage 33 is disposed on the arm 326, and is used to correct a position of the print head 5, specifically, to cancel vibration of the print head 5. As shown in FIG. 2, the moving stage 33 includes a base portion 330 supported by the arm 326, a movable stage 331 movable with respect to the base portion 330, and a piezoelectric drive section 332 that moves the movable stage 331 with respect to the base portion 330.

In addition, the movable stage 331 has a first stage 331a that moves linearly in a first direction A with respect to the base portion 330, and a second stage 331b that moves linearly in a second direction B orthogonal to the first direction A with respect to the first stage 331a. The print head 5 is supported by the second stage 331b.

In addition, the piezoelectric drive section 332 has a first stage drive section 332a which moves the first stage 331a in the first direction A with respect to the base portion 330, and a second stage drive section 332b which moves the second stage 331b in the second direction B with respect to the first stage 331a. The first and second stage drive sections 332a and 332b are respectively provided with a piezoelectric actuator MM that is driven by utilizing expansion and contraction of a piezoelectric element by energization, and an encoder EE that detects the moving amount of the first and second stages 331a and 331b, and move the first and second stages 331a and 331b by transmitting vibration of the piezoelectric actuator MM to the first and second stages 331a and 331b. According to such a configuration, the moving amount and the moving speed of the first and second stages 331a and 331b can be controlled finely and with high accuracy, and further, the switching of the moving direction becomes quick. It is also possible to reduce the size and weight of the moving stage 33. Therefore, it is possible to more accurately correct the position of the print head 5.

However, the configuration of the moving stage 33 is not particularly limited. For example, the first and second stage drive sections 332a and 332b may have a configuration using a driving source other than the piezoelectric actuators, such as a motor that rotates by energization. Further, the moving stage 33 may include a third stage that linearly moves in a direction orthogonal to the first direction A and the second direction B, and a fourth stage that rotationally moves around an axis orthogonal to the first direction A and the second direction B. Further, the moving stage 33 may be omitted. In this case, the print head 5 may be attached to the arm 326.

Although the robot main body 3 has been described above, the configuration of the robot main body 3 is not particularly limited. For example, the number of arms included in the robot arm 32 is not limited to six. Further, the robot main body 3 may be a dual-arm robot, a horizontal articulated robot (SCARA robot), or the like. Further, the robot main body 3 may not be fixed to a mounting table, a floor, or the like, and may be self-propelled.

### Print Head 5

As shown in FIG. 2, the print head 5 is disposed on the second stage 331b. The print head 5 is not particularly limited, but is a piezoelectric drive type ink jet head in the present embodiment. As shown in FIGS. 3 and 4, the print head 5 has a configuration in which a nozzle plate 51, a pressure chamber forming substrate 52, a vibrating plate 53, and a sealing portion 54 are laminated, and includes a reservoir 561, which is a common ink chamber, a plurality of ink chambers 562, which are branched from the reservoir 561, and a plurality of nozzles 563 which are formed in each ink chamber 562. The plurality of ink chambers 562 are arranged in a row in a direction orthogonal to the printing trajectory Q. A piezoelectric vibrating element 564 is disposed on the vibrating plate 53 that forms a ceiling portion of each ink chamber 562.

In the print head 5 having such a configuration, the ink I is supplied from the reservoir 561 to each ink chamber 562. Then, an ink discharge voltage is applied to the piezoelectric vibrating element 564 at a predetermined timing for each ink chamber 562 to vibrate the piezoelectric vibrating element 564, thereby discharging the ink I from the nozzle 563. Therefore, by discharging the ink I from each nozzle 563 at a predetermined timing to land the ink I on the object W while moving the print head 5 along the printing trajectory Q, a predetermined printing pattern is printed on the object W.

However, the configuration of the print head 5 is not particularly limited. For example, a plurality of print heads 5 may be arranged along the printing trajectory Q, thereby enabling a configuration capable of color printing. Specifically, for example, by arranging along the printing trajectory Q a print head 5 that discharges black ink I, a print head 5 that discharges cyan ink I, a print head 5 that discharges magenta ink I, and a print head 5 that discharges yellow ink I, full-color printing may be enabled. In addition, the print head 5 is not limited to the above-described piezoelectric drive type ink jet head. For example, the ink jet head may also be a thermal type that utilizes a film boiling phenomenon of the ink I, a bubble discharge type that discharges the ink I by generating bubbles in the ink I through application of heat, an electrostatic actuator type that discharges the ink I by displacing and vibrating a vibrating plate by an electrostatic force, or the like.

### Inertial Sensor 6

As shown in FIGS. 1 and 2, the inertial sensor 6 is disposed in the print head 5 and detects the vibration of the print head 5. The “vibration” means an unnecessary displacement other than the displacement of the print head 5 along the printing trajectory Q. The inertial sensor 6 is not particularly limited as long as vibration can be detected, and for example, a triaxial angular velocity sensor that detects angular velocities around three axes orthogonal to each other can be used.

### Control Device 8

As shown in FIG. 1, the control device 8 is electrically coupled to the robot 2 and controls the drive of the robot 2. Specifically, the control device 8 controls the drive of the robot main body 3, the moving stage 33, the print head 5, and the inertial sensor 6 independently or in conjunction with each other. The control device 8 is formed of, for example, a computer, and includes a processor (CPU) which processes information, a memory which is communicably connected to the processor, and an external interface that performs connection with an external device. Various programs executable by the processor are stored in the memory, and the processor can read and execute the programs and the like stored in the memory.

The configuration of the robot system 1 has been described above. Next, a printing method on the object W using the robot system 1 will be described. In the robot system 1, first, a printing trajectory Q which is a trajectory of the print head 5 is determined based on shape data of the object W. In particular, in the present embodiment, the printing trajectory Q is determined using computer aided design (CAD) data of the object W. Accordingly, it is possible to determine the printing trajectory Q with high accuracy. However, the method of acquiring the shape data of the object W is not limited thereto, and for example, the shape data may be acquired from measurement data obtained by measuring the object W using a measuring instrument such as a 3D scanner.

As shown in FIG. 5, the printing trajectory Q is determined such that a separation distance PG (platen gap) between the print head 5 and the object W is within a predetermined range, and preferably kept at a constant distance. That is, the printing trajectory Q follows a surface of the object W. Therefore, in the printing trajectory Q of the print head 5, control of the robot arm 32 is more complicated and vibration of the print head 5 is more likely to occur in a portion where a rate of change ΔR of curvature R of the object W is large (hereinafter also referred to as a “large curvature change portion W2”) than in a portion where the rate of change ΔR of curvature R of the object W is small (hereinafter also referred to as a “small curvature change portion W1”). This is because the robot arm 32 moves more finely in the large curvature change portion W2, the number of joints to be driven is larger than that in the small curvature change portion W1, and the joints to be driven change during the movement in many cases.

To give some examples, for example, the control is more complicated in the case of driving all of the joints J1 to J6 than in the case of driving only the joints J1 and J2, and the vibration of the robot arm 32 is also likely to be large because all of the joints J1 to J6 are driven. Further, for example, as compared with a case where only the joints J1 and J2 are driven from the beginning to the end, a case where only the joints J1 and J2 are driven at first, the joint J1 is stopped in the middle, and thereafter the joint J3 is driven, that is, a case where the joints to be driven are switched in the middle results in more complicated, and since the joints are stopped or the joints are driven in the middle, the vibration of the robot arm 32 is likely to increase.

Accordingly, in the robot system 1, responsiveness of the robot arm 32 in the large curvature change portion W2 of the printing trajectory Q of the print head 5 is made higher than that in the small curvature change portion W1. According to such a method, it is possible to effectively suppress the vibration of the print head 5 during the movement of the large curvature change portion W2. Therefore, it is possible to effectively suppress the deterioration of print quality in the large curvature change portion W2, and as a result, it is possible to exhibit high print quality.

Here, the rate of change ΔR (%) of the curvature of the object W can be determined as follows. For example, as shown in FIG. 6, a surface of the object W is divided into a plurality of regions Qs at equal intervals along the printing trajectory Q, and the curvature R of each region Qs is obtained. Then, a ratio between curvature R(n) of a region Qs(n) and curvature R(n+1) of a region Qs(n+1) arranged on the front side of the printing trajectory Q with respect to the region Qs(n), that is, {R(n)/R(n+1)}×100, can be obtained as the rate of change ΔR (%). When the rate of change ΔR is less than a predetermined value, the region Qs(n+1) is determined to be the small curvature change portion W1, and when the rate of change ΔR is equal to or greater than the predetermined value, the region Qs(n+1) is determined to be the large curvature change portion W2. However, the method of calculating the rate of change ΔR is not particularly limited.

In the present embodiment, as shown in FIG. 7, the large curvature change portion W2 is further divided into three stages of a first large curvature change portion W21, a second large curvature change portion W22, and a third large curvature change portion W23, and the rate of change ΔR is classified into a total of four. However, the number of classifications is not particularly limited as long as the rate of change ΔR can be classified into at least two of the small curvature change portion W1 and the large curvature change portion W2. In addition, a threshold value at the time of classification is not particularly limited. The number of classifications and the threshold value can be appropriately set according to, for example, quality required for printing, the driving accuracy of the robot system 1, and the like.

Next, a method of changing the responsiveness will be described. Prior to the description, a control method of each of the joints J1 to J6 will be briefly described. As shown in FIG. 8, the control device 8 includes a control section 81 that controls the drive of the joint J1, a control section 82 that controls the drive of the joint J2, a control section 83 that controls the drive of the joint J3, a control section 84 that controls the drive of the joint J4, a control section 85 that controls the drive of the joint J5, and a control section 86 that controls the drive of the joint J6. Since the control sections 81 to 86 have the same configuration, the control section 81 will be representatively described below for convenience of description, and the description of the control sections 82 to 86 will be omitted.

As shown in FIG. 8, the control section 81 includes a position command generation section 811, a position control section 812, a velocity control section 813, a current control section 814, and a vibration feedback generation section 815.

The vibration feedback generation section 815 obtains a motor shaft equivalent arm angular velocity 912 by multiplying an angular velocity ω detected by the inertial sensor 6 by an arm angular velocity scaling coefficient Kgs. In addition, the vibration feedback generation section 815 differentiates with respect to time a motor shaft position 902, which is a rotation angle of the motor M detected by the encoder E, to obtain a motor shaft angular velocity 913, which is an angular velocity of the motor shaft. Next, the vibration feedback generation section 815 obtains a vibration angular velocity 914 by subtracting the motor shaft angular velocity 913 from the motor shaft equivalent arm angular velocity 912. Next, the vibration feedback generation section 815 obtains vibration feedback 915 by multiplying the vibration angular velocity 914 by the feedback gain Kgp.

The position command generation section 811 generates a position command 901 of the motor M based on a program created by a host computer. Such a position command 901 is repeatedly generated for each control cycle of the control section 81. First, the position control section 812 obtains a position deviation 903 by subtracting the motor shaft position 902 detected by the encoder E from the position command 901. Next, the position control section 812 obtains a velocity command 904 by multiplying the position deviation 903 by a position loop proportional gain Kpp.

The velocity control section 813 is configured with proportional-integral control. The velocity control section 813 first adds the velocity command 904 and the vibration feedback 915 generated by the vibration feedback generation section 815 to obtain a velocity loop command 905. Next, the velocity control section 813 obtains a current command 906 by adding an integral term obtained by multiplying an integral value of the velocity loop command 905 by a velocity loop integral gain Kvi to a proportional term obtained by multiplying the velocity loop command 905 by a velocity loop proportional gain Kvp.

The current control section 814 performs control such that a current 907 for driving the motor M coincides with the current command 906, that is, the current 907 follows the current command 906. The motor M is driven by the current 907 controlled by the current control section 814.

The control section 81 has been described above. However, the configuration of the control section 81 is not particularly limited.

As described above, in the configuration in which the robot arm 32 is servo-controlled by the control section 81, the responsiveness of the robot arm 32 can be changed by changing a servo gain used for the servo control. According to such a method, the responsiveness of the robot arm 32 can be easily changed. Specifically, for example, when the feedback gain Kgp by which the vibration angular velocity 914 is multiplied is increased to increase the vibration feedback 915, the responsiveness of the robot arm 32 is increased. Conversely, when the feedback gain Kgp by which the vibration angular velocity 914 is multiplied is decreased to decrease the vibration feedback 915, the responsiveness of the robot arm 32 is decreased. Therefore, in the present embodiment, as shown in the table of FIG. 7, the feedback gain Kgp in the small curvature change portion W1 is set to a reference value ×1, the feedback gain Kgp in the first large curvature change portion W21 is set to the reference value ×1.5, the feedback gain Kgp in the second large curvature change portion W22 is set to the reference value ×2, and the feedback gain Kgp in the third large curvature change portion W23 is set to the reference value ×4. The magnification is an example and is not particularly limited.

In the present embodiment, as shown in FIG. 7, during movement of the print head 5 along the printing trajectory Q, when printing is performed in the regions Qs from No. 1 to No. 7, that is, when the print head 5 passes through the regions Qs from No. 1 to No. 7, the feedback gain Kgp is set to the reference value ×1, when printing is performed in the region Qs of No. 8, the feedback gain Kgp is set to the reference value ×2, and when printing is performed in the regions Qs from No. 9 to No. 16, the feedback gain Kgp is set to the reference value ×1.

In this way, by making the feedback gain Kgp higher than the reference value for the large curvature change portion W2, which is a region where the print head 5 easily vibrates, it is possible to increase the followability of the print head 5 with respect to the printing trajectory Q and to suppress the vibration of the print head 5. However, when the feedback gain Kgp is increased, although the followability is improved, the feedback loop tends to become unstable. Therefore, the feedback gain Kgp is maintained at the reference value in the small curvature change portion W1 which is a region in which the print head 5 is less likely to vibrate, that is, in a region in which the feedback gain Kgp does not need to be increased, and the feedback loop is stabilized by suppressing an increase in the overall feedback gain Kgp. Therefore, according to such a control method, high-quality printing can be achieved. That is, it is possible to perform highly accurate work on the object W using the working tool.

Next, a printing method by the robot system 1 will be described with reference to a flowchart shown in FIG. 9. The printing method by the robot system 1 includes a driving condition determination step S1 of determining a driving condition such as the printing trajectory Q and a printing step S2 of performing printing on the object W based on the driving condition determined in the driving condition determination step S1.

### Driving Condition Determination Step S1

In the driving condition determination step S1, first, the control device 8 acquires shape data of the object W. Next, the control device 8 determines the printing trajectory Q based on the acquired shape data of the object W, the configuration of the print head 5, a printing pattern to be printed on the object W, and the like. That is, in the printing step S2, it is determined how to move the print head 5 with respect to the object W in order to print the printing pattern on the object W. The control device 8 further determines a timing at which the ink I is discharged from each nozzle 563 based on the determined printing trajectory Q and the printing pattern to be printed on the object W.

Next, the control device 8 divides the object W into a plurality of regions Qs along the printing trajectory Q, and determines, for each region Qs, which of the small curvature change portion W1, the first large curvature change portion W21, the second large curvature change portion W22, and the third large curvature change portion W23 the region Qs corresponds to. Then, the control device 8 determines the feedback gain Kgp of each region Qs based on the determination result. As described above, the driving conditions of the printing trajectory Q and the print head 5 are determined, and the driving condition determination step S1 ends.

### Printing Step S2

In the printing step S2, the control device 8 controls the drive of the robot arm 32 to move the print head 5 based on the driving condition determined in the driving condition determination step S1, and discharges the ink I from each nozzle 563 at a predetermined timing. Thus, a predetermined printing pattern is printed on the object W.

The control device 8 further detects the vibration of the print head 5 based on the output of the inertial sensor 6 during the printing along the printing trajectory Q and controls the drive of the moving stage 33 so that the detected vibration is canceled. Specifically, the drive of the moving stage 33 is controlled so that the vibration having an opposite phase to the detected vibration is applied to the print head 5. As a result, vibration of the print head 5 during printing is suppressed, and higher-quality printing is achieved.

The robot system 1 of the present embodiment has been described above. The control method of such a robot system 1 is a control method of the robot system 1 that drives a robot arm 32 holding one of the print head 5, as a working tool 50, and the object W, in the present embodiment, drives the robot arm 32 holding the print head 5 and moves the print head 5 and the object W relative to each other to perform printing as work on the object W with the print head 5, the control method including generating a printing trajectory Q, which is a trajectory of the working tool 50, based on a shape of the object W, and setting responsiveness of the robot arm 32 in a large curvature change portion W2, which is a portion of the printing trajectory Q where a rate of change ΔR of curvature of the object W is large, to be higher than in a small curvature change portion W1, which is a portion where the rate of change ΔR is small. According to such a method, it is possible to effectively suppress the vibration of the print head 5 during the movement of the large curvature change portion W2. Therefore, it is possible to effectively suppress the deterioration of print quality in the large curvature change portion W2, and as a result, it is possible to exhibit high print quality.

In addition, as described above, the robot arm 32 is servo-controlled, and the responsiveness of the robot arm 32 is increased by increasing the feedback gain Kgp which is a servo gain used for the servo control. According to such a method, the responsiveness of the robot arm 32 can be easily increased.

In addition, as described above, the working tool 50 is the print head 5 that discharges the ink I, and the work is printing on the object W by landing the ink I on the object W. According to such a method, high print quality can be exhibited.

As described above, the robot system 1 includes the robot arm 32 that holds one of the print head 5 as the working tool 50 and the object W, and the control device 8 that controls drive of the robot arm 32. The robot system 1 performs printing as work on the object W by the print head 5 by driving the robot arm 32 with the control device 8 and relatively moving the print head 5 and the object W. Then, the control device 8 generates the printing trajectory Q which is a trajectory of the print head 5 based on the shape of the object W, and sets responsiveness of the robot arm 32 in the large curvature change portion W2, which is a portion of the printing trajectory Q where the rate of change ΔR of curvature of the object W is large, to be higher than in the small curvature change portion W1, which is a portion where the rate of change ΔR is small. According to such a configuration, it is possible to effectively suppress the vibration of the print head 5 during the movement of the large curvature change portion W2. Therefore, it is possible to effectively suppress the deterioration of print quality in the large curvature change portion W2, and as a result, it is possible to exhibit high print quality.

### Second Embodiment

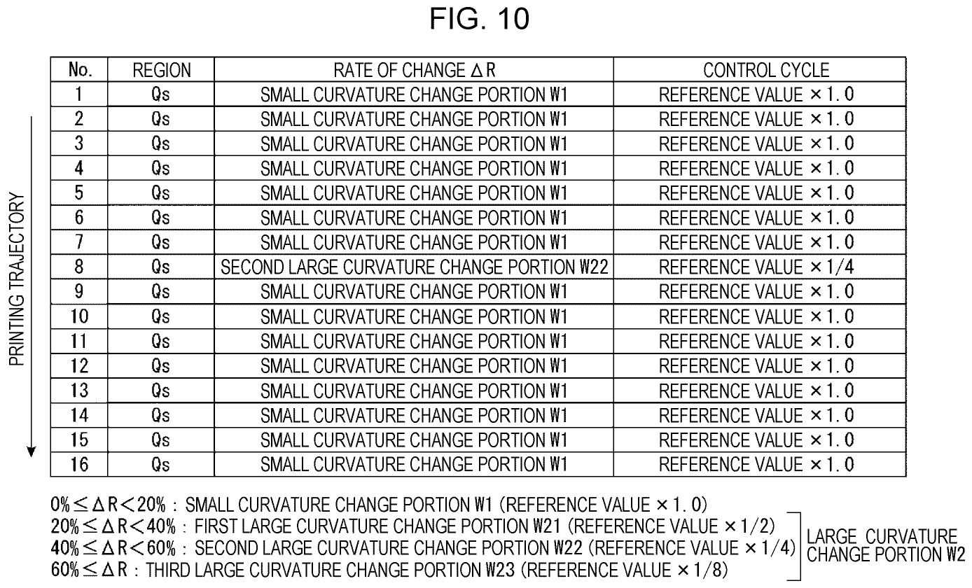

FIG. 10 is a table showing a control cycle for each region used in a second embodiment.

The present embodiment is the same as the robot system of the first embodiment described above except that the method of enhancing the responsiveness of the robot arm 32 is different. In the following description, the present embodiment will be described with a focus on differences from the above-described first embodiment, and description of similar matters will be omitted. In addition, in the drawing according to the present embodiment, the same reference numerals are assigned to the same configurations as those according to the foregoing embodiment.

In the first embodiment described above, the responsiveness of the robot arm 32 is increased by increasing the feedback gain Kgp which is a servo gain. However, in the present embodiment, the responsiveness of the robot arm 32 is increased by shortening the control cycle of the robot arm 32. According to such a method, the responsiveness of the robot arm 32 can be easily changed. As in the first embodiment described above, when the joint J1 is representatively described, the control cycle of the robot arm 32 is a cycle in which the position command 901 of the motor M is generated. That is, by shortening the control cycle of the robot arm 32, an update cycle to the new position command 901 is shortened. Therefore, the vibration of the print head 5 is suppressed, and the followability of the print head 5 with respect to the printing trajectory Q is enhanced.

In the present embodiment, as shown in the table of FIG. 10, a control cycle in the small curvature change portion W1 is set to a reference value ×1, a control cycle in the first large curvature change portion W21 is set to the reference value ×½, a control cycle in the second large curvature change portion W22 is set to the reference value ×¼, and a control cycle in the third large curvature change portion W23 is set to the reference value ×⅛. The magnification is an example and is not particularly limited.

By making the control cycle shorter than the reference value for the large curvature change portion W2, which is a region where the print head 5 easily vibrates, it is possible to increase the followability of the print head 5 with respect to the printing trajectory Q and to suppress the vibration of the print head 5. However, when the control cycle is shortened, although the followability increases, the load on the control device 8 is likely to increase. Therefore, the control cycle is maintained at the reference value for the small curvature change portion W1, which is a region in which the print head 5 is less likely to vibrate, that is, a region in which the control cycle does not need to be shortened, thereby reducing the load on the control device 8. Therefore, according to such a control method, high-quality printing can be achieved.

As described above, in the control method according to the present embodiment, the robot arm 32 is servo-controlled, and the responsiveness of the robot arm 32 is increased by shortening the control cycle of the servo control. According to such a method, the responsiveness of the robot arm 32 can be easily changed.

Such a second embodiment can also exhibit the same effects as in the above-described first embodiment.

### Third Embodiment

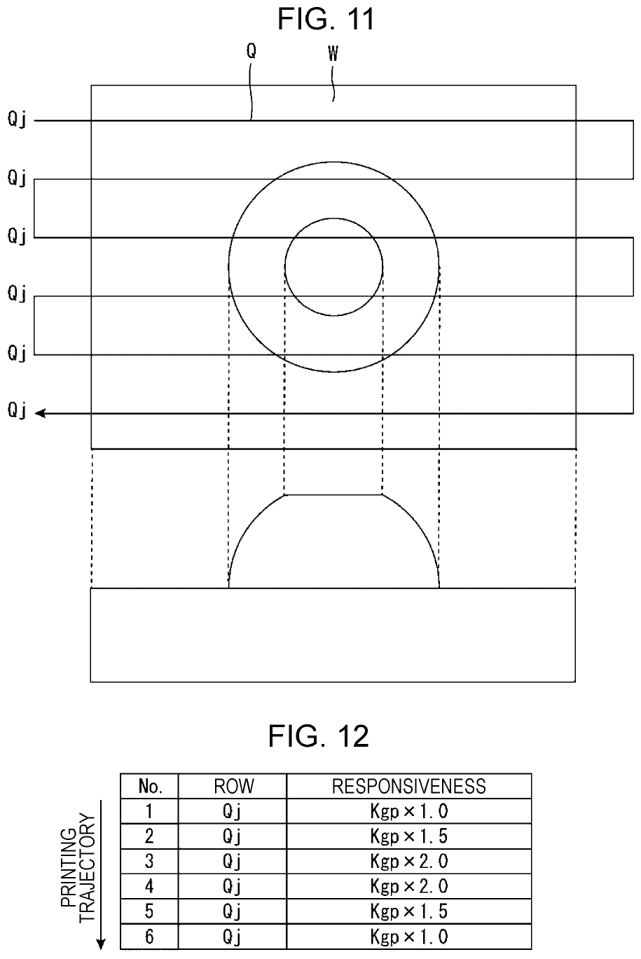

FIG. 11 is a diagram showing an example of a printing trajectory according to a third embodiment. FIG. 12 is a table showing the feedback gain for each row.

The present embodiment is the same as the robot system of the first embodiment described above except that the method of determining the responsiveness of the robot arm 32 is different. In the following description, the present embodiment will be described with a focus on differences from the above-described embodiments, and description of similar matters will be omitted. In each of the drawings according to the present embodiment, the same reference numerals are assigned to the same configurations as those of the above-described embodiment.

In the first embodiment described above, the surface of the object W is divided into the plurality of regions Qs at equal intervals along the printing trajectory Q, and the responsiveness of the robot arm 32 is determined for each region Qs. On the other hand, in the present embodiment, as shown in FIG. 11, the printing trajectory Q meanders on the object W, and a plurality of rows Qj arranged in a direction orthogonal to the moving direction of the print head 5 are included in the printing trajectory Q. Then, as shown in FIG. 12, the responsiveness of the robot arm 32 is determined for each row Qj. According to such a method, since the responsiveness of the robot arm 32 does not change in the middle of the row Qj, it is possible to effectively suppress the vibration of the print head 5 which may occur at the time of switching the responsiveness. Further, since the number of times of switching the responsiveness is reduced as compared with the first embodiment described above, the control is facilitated accordingly.

A method of determining the responsiveness of the robot arm 32 for each row Qj is not particularly limited. For example, the control device 8 first, as in the first embodiment described above, divides each row Qj into a plurality of regions Qs and determines whether each region Qs corresponds to the small curvature change portion W1 or the large curvature change portion W2. Then, the control device 8 determines the responsiveness of the robot arm 32 in each row Qj in accordance with the number of large curvature change portions W2 included in each row Qj. For example, when the large curvature change portion W2 accounts for 5% or less of the total number of regions Qs included in the row Qj, the feedback gain Kgp is set to the reference value ×1.0, when it accounts for more than 5% and 10% or less, the feedback gain Kgp is set to the reference value ×1.5, when it accounts for more than 10% and 15% or less, the feedback gain Kgp is set to the reference value ×2.0, and when it accounts for more than 15%, the feedback gain Kgp is set to the reference value ×4.0. According to such a method, it is possible to easily and appropriately determine the responsiveness of the robot arm 32 for each row Qj.

As described above, in the control method of the robot system 1 according to the present embodiment, the printing trajectory Q includes the plurality of rows Qj arranged side by side, and the control device 8 determines the responsiveness of the robot arm 32 for each row Qj. According to such a method, since the responsiveness of the robot arm 32 does not change in the middle of the row Qj, it is possible to effectively suppress the vibration of the print head 5 which may occur at the time of switching the responsiveness. Further, since the number of times of switching the responsiveness is reduced as compared with the first embodiment described above, the control is facilitated accordingly.

Also with such a third embodiment, it is possible to exhibit the same effects as those of the above-described first embodiment.

### Fourth Embodiment

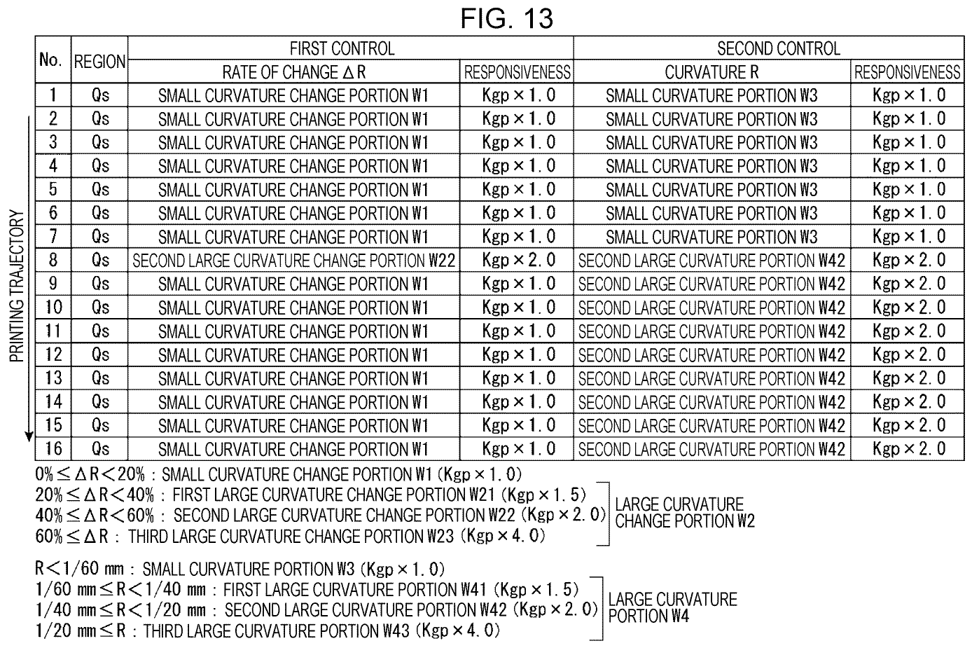

FIG. 13 is a table showing responsiveness of each region used in a fourth embodiment.

The present embodiment is the same as the robot system of the first embodiment described above except that the method of determining the responsiveness of the robot arm 32 is different. In the following description, the present embodiment will be described with a focus on differences from the above-described embodiments, and description of similar matters will be omitted. In addition, in the drawing according to the present embodiment, the same reference numerals are assigned to the same configurations as those according to the foregoing embodiment.

As described above, in the first embodiment, control is performed such that the responsiveness of the robot arm 32 is higher in the large curvature change portion W2 than in the small curvature change portion W1 in the printing trajectory Q. Hereinafter, for convenience of description, this control method is also referred to as a “first control”. On the other hand, in the present embodiment, in addition to the first control, a second control of a method different from the first control is provided, and one of the first control and the second control (the control in which the responsiveness of the robot arm 32 is higher) is selected and executed for each region Qs.

First, the second control will be described. The second control is control for setting responsiveness of the robot arm 32 in a large curvature portion W4, which is a portion where curvature R of the object W is large, to be higher than in a small curvature portion W3, which is a portion where the curvature R of the object W is small, in the printing trajectory Q. Specifically, in the same manner as shown in FIG. 6, the curvature R of each region Qs used in the first control is obtained. A region Qs where the curvature R is less than a predetermined value is defined as the small curvature portion W3, and a region Qs where the curvature R is equal to or more than the predetermined value is defined as the large curvature portion W4. In the present embodiment, as shown in FIG. 13, the large curvature portion W4 is further divided into three stages of a first large curvature portion W41, a second large curvature portion W42, and a third large curvature portion W43, and the curvature R is classified into a total of four. The feedback gain Kgp in the small curvature portion W3 is set to the reference value ×1.0, the feedback gain Kgp in the first large curvature portion W41 is set to the reference value ×1.5, the feedback gain Kgp in the second large curvature portion W42 is set to the reference value ×2.0, and the feedback gain Kgp in the third large curvature portion W43 is set to the reference value ×4.0. Then, the control device 8 controls the drive of the robot arm 32 using the feedback gain Kgp determined in this way. The magnification is an example and is not particularly limited.

As shown in FIG. 13, there are regions Qs in which the feedback gain Kgp is the same in the first control and the second control, and there are also regions Qs in which the feedback gain Kgp is different in the first control and the second control. Therefore, the control device 8 selects and executes, for each region Qs, one of the first control and the second control having higher responsiveness. That is, the control device 8 controls the drive of the robot arm 32 using the feedback gain Kgp in the region Qs in which the feedback gain Kgp is the same in the first control and the second control. Further, in the region Qs where the feedback gain Kgp is higher in the first control than in the second control, the drive of the robot arm 32 is controlled using the feedback gain Kgp of the first control. Conversely, in the region Qs in which the feedback gain Kgp is higher in the second control than in the first control, the drive of the robot arm 32 is controlled using the feedback gain Kgp of the second control. In this way, by selecting and executing one of the first control and the second control having higher responsiveness, it is possible to more effectively suppress the vibration of the print head 5. Therefore, high print quality can be achieved.

As described above, in the control method of the robot system 1 according to the present embodiment, the control device 8 has a first control for setting responsiveness of the robot arm 32 in the large curvature change portion W2, which is a portion where a rate of change ΔR is large, to be higher than responsiveness in the small curvature change portion W1, which is a portion where the rate of change ΔR is small, in the printing trajectory Q, and a second control for setting responsiveness of the robot arm 32 in the large curvature portion W4, which is a portion where curvature R of the object W is large, to be higher than responsiveness in the small curvature portion W3, which is a portion where curvature R of the object W is small, in the printing trajectory Q, and selects and executes one of the first control and the second control which has higher responsiveness of the robot arm 32. According to such a method, it is possible to more effectively suppress the vibration of the print head 5. Therefore, high print quality can be achieved.

Also with such a fourth embodiment, it is possible to exhibit the same effects as those of the above-described first embodiment.

### Fifth Embodiment

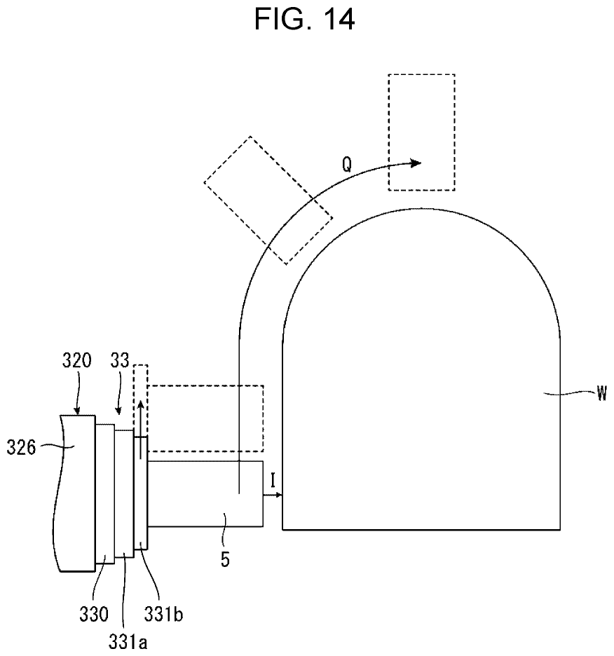

FIG. 14 is a diagram showing a method of moving a print head in a robot system according to a fifth embodiment.

The present embodiment is the same as the robot system of the first embodiment described above, except that the method of moving the print head 5 along the printing trajectory Q is different. In the following description, the present embodiment will be described with a focus on differences from the above-described embodiments, and description of similar matters will be omitted. In addition, in the drawing according to the present embodiment, the same reference numerals are assigned to the same configurations as those according to the foregoing embodiment.

In the first embodiment described above, the print head 5 is moved along the printing trajectory Q by the drive of the robot arm main body 320. On the other hand, in the present embodiment, the print head 5 is moved along the printing trajectory Q by driving only the moving stage 33 in a state where the robot arm main body 320 is stopped. As described above, since the moving stage 33 uses the piezoelectric drive section 332 as a driving source, the moving stage 33 is small in size and light in weight, and the moving amount and the moving speed of the first and second stages 331a and 331b can be finely and highly accurately controlled, and the moving direction can be quickly switched. Therefore, it is possible to effectively suppress the vibration of the print head 5 compared to a case where the print head 5 is moved by driving the robot arm main body 320 (that is, the first embodiment).

Since a movable range of the moving stage 33 is small, the print head 5 may not be able to move over the entire printing trajectory Q with one drive of the moving stage 33. In such a case, for example, the print head 5 may be moved along the printing trajectory Q by repeatedly performing, a plurality of times, a step of driving the robot arm main body 320 to set the print head 5 to a predetermined position and posture, and driving only the moving stage 33 in a state where the robot arm main body 320 is stopped, to move the print head 5 along the printing trajectory Q.

As described above, in the present embodiment, since the print head 5 is moved along the printing trajectory Q by driving the moving stage 33, the responsiveness of the moving stage 33 in the large curvature change portion W2 is set to be higher than that in the small curvature change portion W1 in the printing trajectory Q of the print head 5. According to such a method, it is possible to effectively suppress the vibration of the print head 5 during the movement of the large curvature change portion W2. Therefore, it is possible to effectively suppress the deterioration of print quality in the large curvature change portion W2, and as a result, it is possible to exhibit high print quality.

In this case, the control device 8 controls the drive of the first and second stage drive sections 332a and 332b in the same manner as the control section 81 of the joint J1 shown in FIG. 8. Then, the responsiveness of the moving stage 33 is improved by increasing the servo gain used for the servo control, specifically, the feedback gain Kgp. Alternatively, the responsiveness of the moving stage 33 is improved by shortening the control cycle of the moving stage 33. According to such a method, the responsiveness of the robot arm 32 can be easily changed.

As described above, the robot arm 32 includes the robot arm main body 320 and the moving stage 33. In addition, the moving stage 33 includes the base portion 330 which is supported by the distal end portion of the robot arm main body 320, the movable stage 331 which is movable with respect to the base portion 330 and on which the print head 5 is supported, and the piezoelectric drive section 332 which moves the movable stage 331 with respect to the base portion 330. Then, the control device 8 performs printing by driving the moving stage 33 and moving the print head 5 with respect to the object W in a state where the robot arm main body 320 is stopped, and sets responsiveness of the moving stage 33 in the large curvature change portion W2 to be higher than responsiveness in the small curvature change portion W1 in the printing trajectory Q. According to such a method, it is possible to more effectively suppress the vibration of the print head 5. Therefore, high print quality can be achieved.

Also with such a fifth embodiment, it is possible to exhibit the same effects as those of the above-described first embodiment.

### Sixth Embodiment

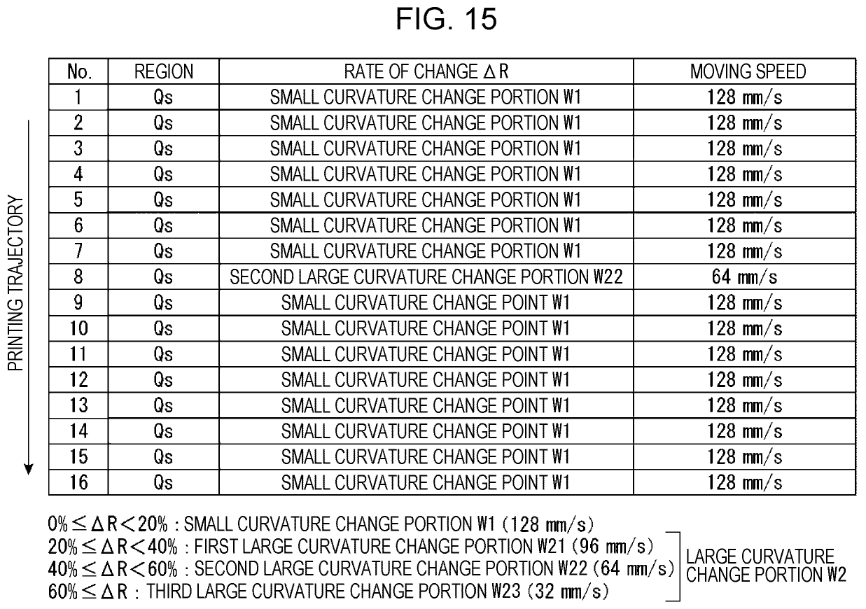

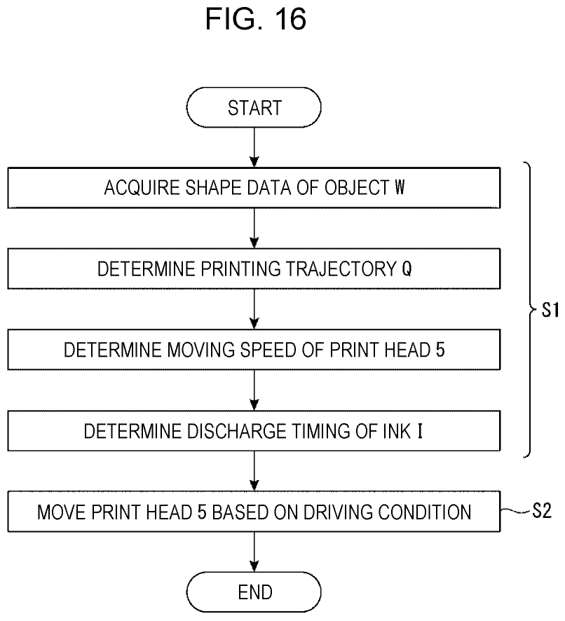

FIG. 15 is a table showing a moving speed for each region used in a sixth embodiment. FIG. 16 is a flowchart for explaining the printing method.

The present embodiment is the same as the robot system of the first embodiment described above, except that the method of suppressing the vibration of the print head 5 is different. In the following description, the present embodiment will be described with a focus on differences from the above-described embodiments, and description of similar matters will be omitted. In each of the drawings according to the present embodiment, the same reference numerals are assigned to the same configurations as those of the above-described embodiment.

In the first embodiment described above, the vibration of the print head 5 in the large curvature change portion W2 is suppressed by increasing the responsiveness of the robot arm 32. However, in the present embodiment, the vibration of the print head 5 in the large curvature change portion W2 is suppressed by decreasing the moving speed of the print head 5, that is, slowing down the moving speed of the print head 5.

As described in the first embodiment, in the printing trajectory Q of the print head 5, the control of the robot arm 32 is more complicated and the vibration of the print head 5 is likely to be larger in the large curvature change portion W2 than in the small curvature change portion W1. Therefore, in the robot system 1 of the present embodiment, in the printing trajectory Q of the print head 5, the moving speed of the print head 5 in the large curvature change portion W2 is set to be lower than that in the small curvature change portion W1. In this way, by lowering the moving speed of the print head 5, it is possible to effectively suppress the vibration of the print head 5 during the movement of the large curvature change portion W2. Therefore, it is possible to effectively suppress the deterioration of print quality in the large curvature change portion W2, and as a result, it is possible to exhibit high print quality.

Next, a method of changing the moving speed of the print head 5 will be described. For example, the control device 8 first, as in the first embodiment described above, divides the surface of the object W into the plurality of regions Qs at equal intervals along the printing trajectory Q, obtains the curvature R of each region Qs, and determines which of the small curvature change portion W1, the first large curvature change portion W21, the second large curvature change portion W22, and the third large curvature change portion W23 each region Qs corresponds to based on the obtained curvature R. Then, as shown in FIG. 15, a moving speed of the print head 5 in the small curvature change portion W1 is set to 128 mm/s, a moving speed of the print head 5 in the first large curvature change portion W21 is set to 96 mm/s, a moving speed of the print head 5 in the second large curvature change portion W22 is set to 64 mm/s, and a moving speed of the print head 5 in the third large curvature change portion W23 is set to 32 mm/s. The moving speed is an example and is not particularly limited.

Then, printing on the object W is performed by moving the print head 5 along the printing trajectory Q based on the moving speed of the print head 5 determined as described above. According to such a method, it is possible to effectively suppress the vibration of the print head 5 during the movement of the large curvature change portion W2. Therefore, it is possible to effectively suppress the deterioration of print quality in the large curvature change portion W2, and as a result, it is possible to exhibit high print quality.

Next, a printing method by the robot system 1 will be described with reference to a flowchart shown in FIG. 16. The printing method by the robot system 1 includes a driving condition determination step S1 of determining a driving condition such as the printing trajectory Q and a printing step S2 of performing printing on the object W based on the driving condition determined in the driving condition determination step S1.

### Driving Condition Determination Step S1

As shown in FIG. 16, in the driving condition determination step S1, first, the control device 8 acquires shape data of the object W. Next, the control device 8 determines the printing trajectory Q based on the acquired shape data of the object W, the configuration of the print head 5, a printing pattern to be printed on the object W, and the like. Next, the control device 8 divides the object W into a plurality of regions Qs along the printing trajectory Q, determines, for each region Qs, which of the small curvature change portion W1, the first large curvature change portion W21, the second large curvature change portion W22, and the third large curvature change portion W23 the region Qs corresponds to, and determines the moving speed of the print head 5 in each region Qs based on the determination result. The control device 8 further determines a timing at which the ink I is discharged from each nozzle 563 based on the determined printing trajectory Q and moving speed, and the printing pattern to be printed on the object W. As described above, the driving conditions of the printing trajectory Q and the print head 5 are determined, and the driving condition determination step S1 ends.

### Printing Step S2

In the printing step S2, the control device 8 controls the drive of the robot arm main body 320 to move the print head 5 based on the driving condition determined in the driving condition determination step S1, and discharges the ink I from each nozzle 563 at a predetermined timing. Thus, a predetermined printing pattern is printed on the object W.

As described above, the control method of the robot system 1 of the present embodiment is a control method of the robot system 1 that drives a robot arm 32 holding one of the print head 5, as a working tool 50, and the object W, in the present embodiment, drives the robot arm 32 holding the print head 5 and moves the print head 5 and the object W relative to each other to perform printing as work on the object W with the print head 5, the control method including generating a printing trajectory Q, which is a trajectory of the working tool 50, based on a shape of the object W, and setting the moving speed of the print head 5 in the large curvature change portion W2, which is a portion of the printing trajectory Q where the rate of change ΔR of curvature of the object W is large, to be lower than that in the small curvature change portion W1, which is a portion where the rate of change ΔR is small. According to such a method, it is possible to effectively suppress the vibration of the print head 5 during the movement of the large curvature change portion W2. Therefore, it is possible to effectively suppress the deterioration of print quality in the large curvature change portion W2, and as a result, it is possible to exhibit high print quality.

As described above, the robot system 1 includes the robot arm 32 that holds one of the print head 5 as the working tool 50 and the object W, and the control device 8 that controls drive of the robot arm 32. The robot system 1 performs printing as work on the object W by the print head 5 by driving the robot arm 32 with the control device 8 and relatively moving the print head 5 and the object W. Then, the control device 8 generates the printing trajectory Q which is a trajectory of the print head 5 based on the shape of the object W, and sets the moving speed of the print head 5 in the large curvature change portion W2, which is a portion of the printing trajectory Q where the rate of change ΔR of curvature of the object W is large, to be lower than that in the small curvature change portion W1, which is a portion where the rate of change ΔR is small. According to such a configuration, it is possible to effectively suppress the vibration of the print head 5 during the movement of the large curvature change portion W2. Therefore, it is possible to effectively suppress the deterioration of print quality in the large curvature change portion W2, and as a result, it is possible to exhibit high print quality.

Also with such a sixth embodiment, it is possible to exhibit the same effects as those of the above-described first embodiment.

### Seventh Embodiment

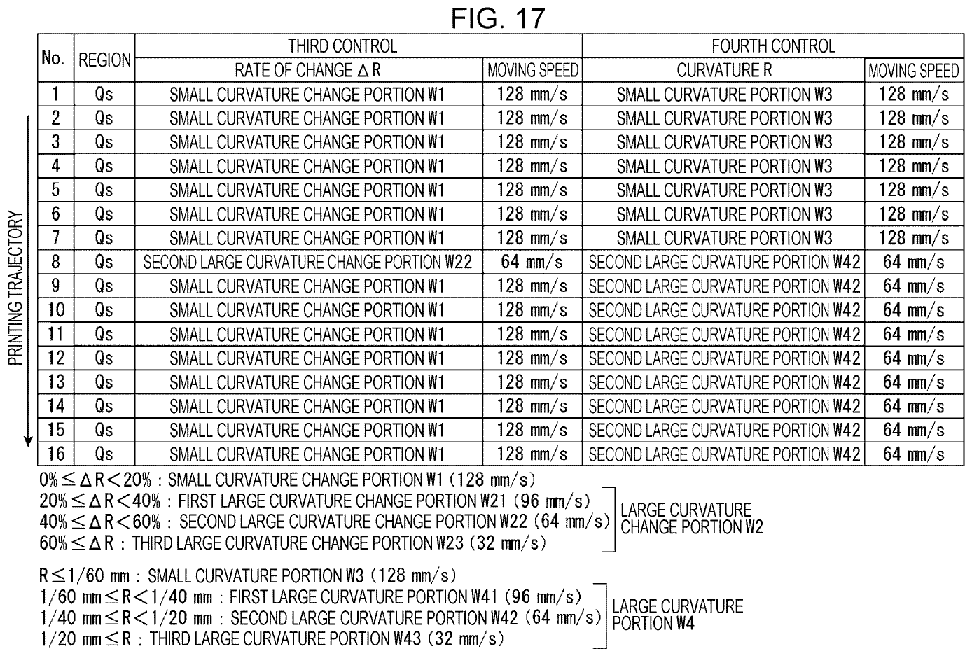

FIG. 17 is a table showing a moving speed for each region used in a seventh embodiment.

The present embodiment is the same as the robot system of the sixth embodiment described above, except that the method of determining the moving speed of the print head 5 is different. In the following description, the present embodiment will be described with a focus on differences from the above-described embodiments, and description of similar matters will be omitted. In addition, in the drawing according to the present embodiment, the same reference numerals are assigned to the same configurations as those according to the foregoing embodiment.

As described above, in the sixth embodiment, control is performed such that the moving speed of the print head 5 is lower in the large curvature change portion W2 than in the small curvature change portion W1 in the printing trajectory Q. Hereinafter, for convenience of description, this control method is also referred to as a “third control”. On the other hand, in the present embodiment, in addition to the third control, a fourth control of a method different from the third control is provided, and one of the third control and the fourth control (one in which the moving speed of the print head 5 is lower) is selected and executed for each region Qs.

First, the fourth control will be described. The fourth control is control for setting the moving speed of the print head 5 in the large curvature portion W4, which is a portion where curvature R of the object W is large, to be lower than that in the small curvature portion W3, which is a portion where the curvature R of the object W is small, in the printing trajectory Q. Specifically, in the same manner as shown in FIG. 6, the curvature R of each region Qs used in the first control is obtained. A region Qs where the curvature R is less than a predetermined value is defined as the small curvature portion W3, and a region Qs where the curvature R is equal to or more than the predetermined value is defined as the large curvature portion W4. In the present embodiment, as shown in FIG. 17, the large curvature portion W4 is further divided into three stages of a first large curvature portion W41, a second large curvature portion W42, and a third large curvature portion W43, and the curvature R is classified into a total of four. Then, a moving speed of the print head 5 in the small curvature portion W3 is set to 128 mm/s, a moving speed of the print head 5 in the first large curvature portion W41 is set to 96 mm/s, a moving speed of the print head 5 in the second large curvature portion W42 is set to 64 mm/s, and a moving speed of the print head 5 in the third large curvature portion W43 is set to 32 mm/s.

As shown in FIG. 17, there are regions Qs in which a moving speed of the print head 5 is the same in the third control and the fourth control, and there are also regions Qs in which the moving speed of the print head 5 is different in the third control and the fourth control. Therefore, the control device 8 selects and executes, for each region Qs, one of the third control and the fourth control having a lower moving speed. That is, the control device 8 controls the drive of the robot arm main body 320 by using the moving speed in the regions Qs in which the moving speed of the print head 5 is the same in the third control and the fourth control. For the regions Qs in which the moving speed of the print head 5 in the third control is lower than that in the fourth control, the drive of the robot arm main body 320 is controlled by using the moving speed in the third control. On the contrary, for regions Qs in which the moving speed of the print head 5 is lower in the fourth control than in the third control, the drive of the robot arm main body 320 is controlled by using the moving speed in the fourth control. In this way, by selecting and executing one of the third control and the fourth control having a lower moving speed of the print head 5, it is possible to more effectively suppress the vibration of the print head 5. Therefore, high print quality can be achieved.

As described above, in the control method for the robot system 1 according to the present embodiment, the control device 8 has a third control for setting a moving speed of the print head 5 in the large curvature change portion W2, which is a portion where a rate of change ΔR is large, to be lower than a moving speed in the small curvature change portion W1, which is a portion where the rate of change ΔR is small, in the printing trajectory Q, and a fourth control for setting a moving speed of the print head 5 in the large curvature portion W4, which is a portion where curvature R of the object W is large, to be lower than a moving speed in the small curvature portion W3, which is a portion where the curvature R of the object W is small, in the printing trajectory Q, and selects and executes one of the third control and the fourth control having a lower moving speed of the print head 5. According to such a method, it is possible to more effectively suppress the vibration of the print head 5. Therefore, high print quality can be achieved.

Also with such a seventh embodiment, it is possible to exhibit the same effects as those of the above-described first embodiment.

As described above, the control method and the robot system according to the present disclosure have been described based on the shown embodiments, but the present disclosure is not limited thereto, and the configurations of the respective sections and the steps can be replaced with any configurations and steps having the same functions. Additionally, any other configuration or step may be added to the present disclosure. In addition, each embodiment may be combined as appropriate.

1. A control method of a robot system that drives a robot arm holding one of a working tool and an object and moves the working tool and the object relative to each other to perform work on the object with the working tool, the control method comprising:
generating a trajectory of the one based on a shape of the object; and
setting responsiveness of the robot arm in a portion of the trajectory where a rate of change of curvature of the object is large to be higher than responsiveness in a portion where the rate of change is small.

2. The control method according to claim 1, wherein
the robot arm includes a robot arm main body and a moving stage,
the moving stage includes a base portion which is supported by a distal end portion of the robot arm main body, a movable stage which is movable with respect to the base portion and on which the working tool is supported, and a piezoelectric drive section which moves the movable stage with respect to the base portion,
the work is performed by driving the moving stage to move the working tool with respect to the object in a state where the robot arm main body is stopped, and
responsiveness of the moving stage in a portion of the trajectory where the rate of change is large is set to be higher than responsiveness in a portion where the rate of change is small.

3. The control method according to claim 1, wherein
the robot arm is servo-controlled, and
the responsiveness is increased by increasing a servo gain used for the servo control.

4. The control method according to claim 1, wherein
the robot arm is servo-controlled, and
the responsiveness is increased by shortening a control cycle of the servo control.

5. The control method according to claim 1, wherein
the trajectory includes a plurality of rows arranged side by side, and
the responsiveness is determined for each row.

6. The control method according to claim 1, wherein
the working tool is a print head that discharges ink, and
the work is printing on the object by landing the ink on the object.

7. The control method according to claim 1, further comprising:
performing a first control in which responsiveness of the robot arm in a portion of the trajectory where the rate of change is large is set to be higher than responsiveness in a portion where the rate of change is small;
performing a second control in which responsiveness of the robot arm in a portion of the trajectory where curvature of the object is large is set to be higher than responsiveness in a portion where the curvature of the object is small; and
selecting and executing one of the first control and the second control which has higher responsiveness of the robot arm.

8. A control method of a robot system that drives a robot arm holding one of a working tool and an object and moves the working tool and the object relative to each other to perform work on the object with the working tool, the control method comprising:
generating a trajectory of the one based on a shape of the object; and
setting a moving speed of the working tool in a portion of the trajectory where a rate of change of curvature of the object is large to be lower than a moving speed in a portion where the rate of change is small.

9. The control method according to claim 8, further comprising:
performing a third control in which the moving speed of the working tool in the portion of the trajectory where the rate of change is large is set to be lower than the moving speed in the portion where the rate of change is small;
performing a fourth control in which the moving speed of the working tool in the portion of the trajectory where the curvature of the object is large is set to be lower than the moving speed in the portion where the curvature is small; and
selecting and executing one of the third control and the fourth control which has a lower moving speed of the working tool.

10. A robot system comprising:
a robot arm configured to hold one of a working tool and an object; and
a control device configured to control drive of the robot arm, wherein the control device drives the robot arm and relatively moves the working tool and the object to perform work on the object by the working tool,
the control device generates a trajectory of the one based on a shape of the object, and
sets either responsiveness of the robot arm in a portion of the trajectory where a rate of change of curvature of the object is large to be higher than responsiveness in a portion where the rate of change is small, or a moving speed of the working tool in a portion of the trajectory where a rate of change of curvature of the object is large to be lower than a moving speed in a portion where the rate of change is small.
